(19) United States
(12) Patent Application Publication
(10) Pub. No.: US 2025/0245520 A1
(43) Pub. Date: Jul. 31, 2025

(54) Computer-Implemented Method and System for Anomaly Detection in Sensor Data

(71) Applicant: Siemens AG Österreich, Wien (AT)

(72) Inventors: Thomas BLUMAUER-HIEßL, Wien (AT); Safoura REZAPOUR LAKANI, Wien (AT); Daniel SCHALL, Hollabrunn (AT)

(21) Appl. No.: 18/698,826

(22) PCT Filed: Oct. 5, 2022
(86) PCT No.: PCT/EP2022/077660

§ 371 Date: Apr. 5, 2024

(30) Foreign Application Priority Data
Oct. 6, 2021 (WO) PCT/EP2021/077543

(51) Int. Cl. G06F 11/07

(52) U.S. Cl. CPC G06F 11/076; G06F 11/0709

(57) ABSTRACT

A computer-implemented method for anomaly detection in sensor data includes a) generating and training a first and second local model via an autoencoder and determining a local threshold value for each local model output variable; b) transmitting local model weightings and local threshold values to a server; c) generating and training a global model via the autoencoder and determining global threshold values for global model output variables; d) transmitting the global model weightings and global threshold value to the first client, and adopting global model weightings for the first local model; e) capturing first sensor data by a first sensor; f) applying the first sensor data to the first local model and determining the first local model output variable of the first client; and g) detecting an anomaly for the sensor data, if the local model output variable is outside a range that is fixed by the global threshold value.

### CROSS-REFERENCE TO RELATED APPLICATIONS

This is a U.S. national stage of application No. PCT/EP2022/077660 filed 5 Oct. 2022. Priority is claimed on World Intellectual Property Organization Application No. PCT/EP2021/077543 filed 6 Oct. 2021, the content of which is incorporated herein by reference in its entirety.

### BACKGROUND OF THE INVENTION

### 1. Field of the Invention

The invention relates to a computer-implemented method, a system for anomaly detection in sensor data, a data structure and its use, a computer program, an electronically readable data carrier and a data carrier signal.

### 2. Description of the Related Art

In order to detect anomalies in industrial processes, such as misplacements of transistors on a circuit board using computer-assisted image processing, a neural network in the form of a “machine learning” (ML) model can be used.

However, it is often time-consuming to train the ML model with images accordingly. If the same process is used at several production sites, then it is often undesirable, for example, to share image data from the local network in a system that could also be accessed by external parties because this would possibly allow unwanted insight into the production parameters. Accordingly, this may result in an ML model having to be retrained at another production site, which is time-consuming and expensive, in order not to share data for reasons of operational security.

Consequently, ML models are frequently not trained with sufficient data, which can lead to low accuracy in anomaly detection.

The publication SCHNEIBLE, JOSEPH ET AL: “Anomaly detection on the edge”, MILCOM 2017-2017 IEEE MILITARY COMMUNICATIONS CONFERENCE (MILCOM), IEEE; Oct. 23, 2017 (2017-10-23), pp.: 678-682, XP033265066 describes a traditional system based on federated learning, in which model data of a plurality of clients is aggregated by a server and distributed to clients. For operation, however, the application of the federated model must in turn be adjusted individually and locally, for example, by a threshold value, which is elaborate and expensive.

### SUMMARY OF THE INVENTION

It is an object of the invention to provide a method that makes it possible to share ML data across a plurality of production sites in a manner that is accurate, reliable and data protection-compliant, i.e., anonymous, and that offers improved accuracy during the operation of a client system, as well as simplified operation.

This and other objects and advantages are achieved in in accordance with the invention by a method comprising:
a) generating and training a first and at least one second local model in each case based on an autoencoder, where each model comprises local model weightings and a local model output variable, and determining a local threshold value for the respective local model output variable with the aid of the mean value and/or the standard deviation of the local threshold values via a first or at least one second client,
b) transmitting the local model weightings and the local threshold values from the first and the at least one second client to a server,
c) generating and training a global model based on the autoencoder, comprising global model weightings and a local model output variable, using the local model weightings of the first and at least the at least one second client, and determining a global threshold value for the global model output variable with the aid of the mean value and/or the standard deviation of the local threshold values via the server,
d) transmitting the global model weightings and global threshold value to the first client, and adopting the global model weightings for the first local model of the first client,
e) capturing first sensor data by a first sensor means, which the first client possesses,
f) applying the first sensor data to the first local model and determining the local model output variable of the first client,
g) detecting an anomaly for the sensor data by the first client if the local model output variable is outside a range which is fixed by the global threshold value.

An autoencoder is used as an ML model, which is trained with “OK” data that uses, for example, a captured correct image of the production step to be tested in image processing.

An autoencoder is an artificial neural network that is used to learn efficient coding. The aim of an autoencoder is to learn a compressed representation (encoding) for a set of data and thus also to extract essential features. As a result, it can be used for dimensional reduction. Here, the autoencoder has the aim of encoding and decoding the transistor images, for example, as well as possible, i.e., reconstructing them.

Therefore, if the trained autoencoder is then applied to “Not OK” data, then there will most likely be a significant mismatch of the decoded images, which is described as a “reconstruction error”. If this reconstruction error is above a certain threshold value, then the transistor images may be considered abnormal and an anomaly is detected.

In addition to the model with its model weightings, the accuracy for detecting an anomaly is also formed by the threshold value for the reconstruction error. For example, a large volume of training data should be processed for both the model and the threshold value. In other words, a local threshold value, analogous to the model of an autoencoder, is likewise an anonymized model, which is formed, for example, from a mean value and/or a standard deviation of training data for a respective local threshold value, therefore distinguishing local threshold values from a global threshold value.

The respective threshold values of the clients may differ from one another, i.e., between individual clients, for example, in quality, for example, depending on a respective amount of training data. It may thus be advantageous to federate a threshold value in addition to a model and to aggregate threshold value data via a server and distribute it to clients. This can, for example, simplify the training of an individual client and improve accuracy by federating both the model and the threshold value. Local threshold values of individual clients, which are determined independently of one another, are likewise transmitted to the server and federated.

It is also possible to indicate metadata relating to the threshold values in order to indicate the properties on which the threshold values are based. This metadata can be used on the server, for example, to take into account the weights of individual clients with regard to their threshold values and to take greater account of those threshold values which have been determined based on large training datasets with a higher weighting in the global threshold value.

It is clear that preferably only anonymized local threshold values, such as the mean value and/or the standard deviation of the local threshold values, are used for the threshold values of local clients, in order to take into account data protection concerns. For example, if such a method is applied to a plurality of production sites where anomalies occur in their processes, autoencoders will be used by a plurality of customers.

However, often not every autoencoder is trained with sufficient data, which can lead to low accuracy in anomaly detection. Here, data is shared between customers in order to increase the performance of trained autoencoders. However, this may not always be possible everywhere due to data protection concerns.

On the other hand, “Federated Learning” (FL) can be used to synchronize the knowledge of the autoencoder. Federated Learning is an ML technique that enables an ML model to be trained across a plurality of decentralized edge devices containing local data samples, without exchanging these themselves.

In an embodiment of the invention, the respective local model is trained with training data that can be assigned to an anomaly-free state in the sensor data. As a result, it can be achieved that an anomaly is detected particularly well, even if the anomaly has not occurred previously and has not been trained as such. Overall, the detection rate and the reliability thereof can be improved as a result.

In an embodiment of the invention, a respective model output variable is formed by at least one parameter value, and the respective threshold value is defined by at least one corresponding assignable value or a range limit of a range. As a result, it can be achieved that one or more output values or parameter values in the output variable of the model map a reconstruction error. Accordingly, each of the parameter values can be assigned a valid value or a valid value for a range limit of a range in which there is no anomaly and, consequently, an invalid parameter value is associated with an anomaly.

In a further embodiment of the invention, the sensor data and training data is formed as image data.

The method in accordance with the disclosed embodiments of the invention is suitable for all sensors and formats of sensor data, but in particular for video data, because a large volume of individual items of data in the form of image pixels is determined for such a measurement, for which a combination of autoencoders and federated learning can achieve a particularly high detection quality.

In another embodiment of the invention, the statistical methods for determining a respective model output variable are implemented by applying the mean value and/or the standard deviation. In this way, an anonymization of the sensor data can be carried out in a particularly simple manner.

A client and a server are understood to be computing apparatuses connected to one another with memories, a client being located locally in an application and being formed, for example, at an edge, and a server as a central element connecting one or more clients for communication purposes.

In a further embodiment of the invention, the global model weightings and the global threshold value are transmitted from the server to the at least one second client, which has an autoencoder with a similar local model, where the similarity is determined via predefined ranges and their limit values for the local model weightings between the first and at least one second client. As a result, it can be achieved that, for example, only similar clients use a global model for data processing.

The similarity can be determined by a cluster of clients whose model weightings and the relationships between individual model weightings are in similar value ranges. Such value ranges can be defined in advance based on the properties of the models or the connected technical devices and their sensors.

A model is intended to map a technical device in properties of interest, enabling the properties to be detected with the aid of sensor means and described in sensor data. If non-similar clients or their models are included in a global model, then this may result in the global model becoming inaccurate.

In a further embodiment of the invention, for a respective local threshold value, metadata with regard to the local threshold value and the first and at least one second local model is also captured by a first or at least one second client and transmitted to the server, and the metadata is applied when generating and training the global model, for example, when weighting the individual model weightings. As a result, a particularly good combination of model data and training data can be formed synergistically, which can be taken into account in the global models for autoencoders and threshold value in a correspondingly more weighted manner. Particularly good detection of anomalies can result from this.

The joint, combined application of a federated model with a federated threshold value forms synergies in accordance with the invention, and to which combination the metadata provides indications. The metadata can indicate particularly favorable value ranges for the autoencoder model and threshold value model relevant to the respective client and their advantageous combinations for a client. The metadata can be captured and provided when generating and training the models for the autoencoder model and threshold value model.

The objects and advantages are also achieved in accordance with the invention by a computer-implemented data structure, comprising a global model based on an autoencoder, comprising global model weightings and a global threshold value.

The objects and advantages in accordance with the invention are also achieved by the use of the data structure in accordance with the invention in a memory on a server or a client in the method in accordance with the disclosed embodiments of the invention.

The objects and advantages in accordance with the invention are also achieved by a system for anomaly detection in sensor data, comprising a first and at least one second client that each have a client processor and a client memory, where the system further comprises a sensor and a connected server with a server processor and a server memory, and where the system is configured to performed the method in accordance with the disclosed embodiments of the invention.

In yet a further embodiment of the invention, the sensor is an imaging sensor, such as an inspection camera for a production machine.

The objects and advantages are also achieved in accordance with the invention by a computer program, comprising instructions which, when executed by a computer, cause the computer to perform the method in accordance with the disclosed embodiments of the invention.

The objects and advantages are additionally achieved in accordance with the invention by an electronically readable data carrier with readable control information stored thereon, which comprises at least the computer program in accordance with the invention and is configured such that it implements the method in accordance with the disclosed embodiments of the invention when the data carrier is used in a computing apparatus.

The objects and advantages are further achieved in accordance with the invention by a data carrier signal which transmits the computer program in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail hereinafter with reference to an exemplary embodiment shown in the accompanying drawings, in which:

FIG. 1 shows a schematic view of the method in accordance with the invention with an autoencoder;

FIG. 2 shows an exemplary embodiment with a partial flow chart of the method in accordance with the invention;

FIG. 3 shows an exemplary embodiment of a system in accordance with the invention; and

FIG. 4 shows a flow chart with an exemplary embodiment of the method in accordance with the invention.

### DETAILED DESCRIPTION OF THE EXEMPLARY EMBODIMENT

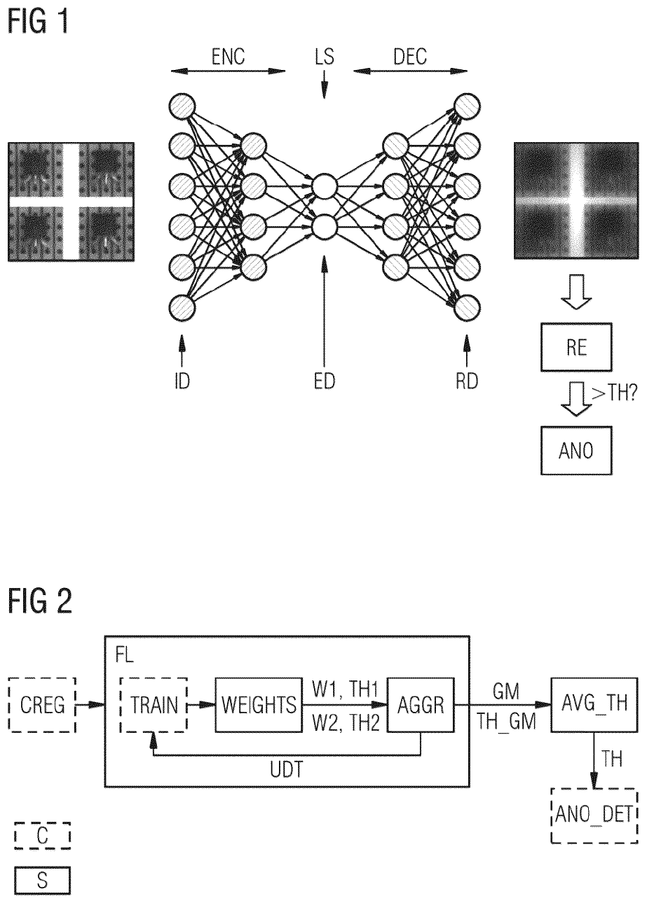

FIG. 1 shows a diagrammatic view of the method in accordance with the invention with an autoencoder.

An encoder ENC processes input data ID into encoded data ED, that represents a latent space LS, i.e., a representation of compressed data.

A decoder DEC in turn processes the encoded data ED into reconstructed data RD. The reconstructed data RD is compared with previously generated model data and a reconstruction error RE is determined. If the reconstruction error RE exceeds a predetermined threshold value TH, then an anomaly ANO is detected.

In FIG. 1, the input data ID is shown in the form of an image captured by an inspection camera with transistors on a semiconductor carrier.

The reconstructed data RD shows the essential features of the transistors, but small local differences in the semiconductor structures or details have been eliminated by using the autoencoder.

The reconstructed data RD therefore forms a generalized form of input data ID and is used in the method in accordance with the invention to form a corresponding model and to detect anomalies ANO if a deviation in the sensor image is sufficiently great compared to the model.

In addition to the model, the invention also detects a threshold value, for example, a discrete value or also a boundary or limit value for a value range that applies to a valid output variable of the reconstructed data RD.

Both the model, which can be represented via its model weightings, and the threshold value are transmitted to a server in the form of anonymized data values, starting from a plurality of clients, and a federated model and a federated threshold value are formed, which in turn can be applied by the clients.

FIG. 2 shows an exemplary embodiment of a partial flow chart of the method in accordance with the invention in which, for reasons of clarity, only one client is shown.

A client is, for example, an edge device that detects a connected technical device (not shown, for example, an electric pump or a production machine) with the aid of sensors of its operating parameters and correspondingly maps it as a mathematical model of an artificial intelligence in the form of an autoencoder according to the preceding figure.

It is clear that for federated learning a plurality of clients is required, with the aid of the data of which an accurate global model is generated, which in turn is passed on to the clients. As a result, a new client can be added to the system, for example, without having to train a model locally. The new client can obtain the global model from a server.

Those aspects of the method that are performed in a client C are shown in dashed lines in the figure.

Those aspects of the method that are performed in a server S are shown in solid lines in the figure.

A customer or client first registers with a corresponding FL-server S in the step CREG.

One or more clients C are each an apparatus with a processor and a memory, which are connected to a central server apparatus S, likewise with a processor and a memory.

The customer/client C trains their own autoencoder in the step TRAIN.

Then the client C uploads the determined weights for their autoencoder to the server S in the step WEIGHTS.

Then, a step AGGR follows, via which the weights of customers/clients C are aggregated for a global model.

The global model is passed on to all clients C involved in a step UDT and the distributed global model is updated accordingly.

The steps TRAIN, WEIGHTS, AGGR and UDT can be repeated as required to perform an update of the global model accordingly.

An update can, for example, be initiated manually by a client or else by adding a further, new client.

The server S now forms a threshold value AVG_TH, for example, by calculating a mean value, which is used for determining the reconstruction error RE in a step ANO_DET in the course of anomaly detection.

An anomaly ANO is detected if a result of the autoencoder provides a value which is above the threshold value AVG_TH.

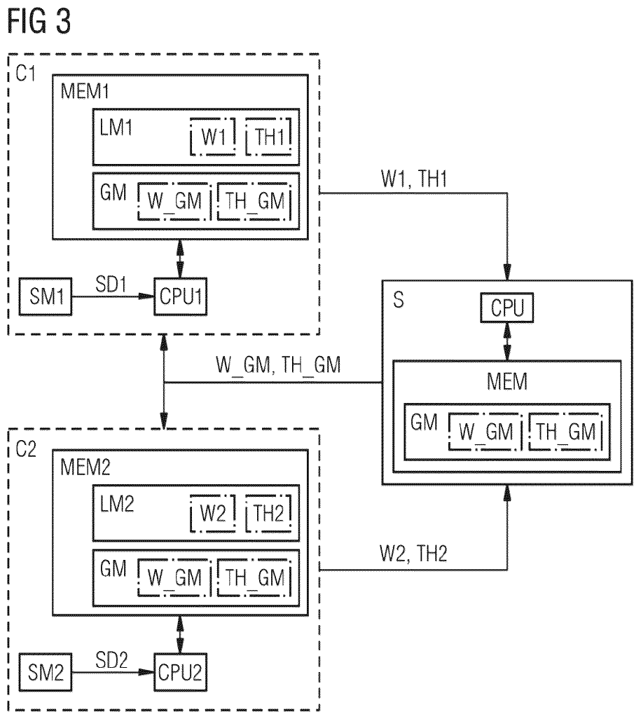

FIG. 3 shows an exemplary embodiment of a system in accordance with the invention.

The system comprises a first client C1 with a client processor CPU1 and a client memory MEM1, as well as a first sensor SM1.

The first client C1 generates and saves a local first model LM1 with first model weightings W1 and a local first threshold value TH1 in the memory MEM1.

Furthermore, the system comprises a second client C2 with a second client processor CPU2 and a second client memory MEM2, as well as a second sensor SM2.

The second client C2 generates and saves a local second model LM2 with second model weightings W2 and a local second threshold value TH2 in the memory MEM2.

Moreover, the system has a server S with a server-processor CPU and a server memory MEM which is connected to the first and second clients C1, C2.

The system is configured to implement the method in accordance with the invention to determine global model weightings W_GM and a global threshold value TH_GM from the local model weightings W1, W2 and local threshold values TH1, TH2 and to distribute them to the first and second clients C1, C2.

The sensors SM1, SM2 are each imaging sensors.

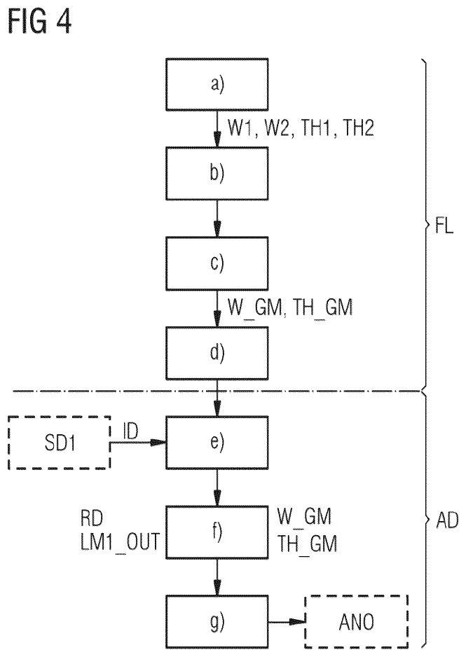

FIG. 4 shows a flow chart with an exemplary embodiment of the method in accordance with the invention.

The method includes:
a) generating and training a first and a second local model based on an autoencoder, where each model comprises local model weightings W1, W2 and a local model output variable RD, and determining a local threshold value TH1, TH2 for the respective local model output variable RD with the aid of a mean value formation by a first or a second client C1, C2,
b) transmitting the local model weightings W1, W2 and the local threshold values TH1, TH2 from the first and second clients C1, C2 to a server S,
c) generating and training a global model GM based on the autoencoder, comprising global model weightings W_GM and a local model output variable RD, using the local model weightings W1, W2 and determining a global threshold value TH_GM for the global model output variable RD, W_GM with the aid of a mean value formation by the server S,
d) transmitting the global model weightings W_GM and global threshold value TH_GM to the first client C1, and adopting the global model weightings W_GM for the first local model LM1 of the first client C1,
e) capturing first sensor data SD1 as input data ID by a first sensor SM1, which the first client C1 possesses, f) applying the first sensor data SD1 to the first local model LM1 and determining the local model output variable LM1_OUT in the form of reconstructed data RD of the first client C1, and
g) detecting an anomaly ANO for the sensor data by the first client C1, if the local model output variable RD or LM1_OUT is outside a range which is fixed by the global threshold value TH_GM.

Steps a) to d) implement an autoencoder with anonymous federated learning FL of models and threshold values across a plurality of clients C1, C2.

Steps e) to g) implement an anomaly detection AD with the aid of an autoencoder, equivalent to the anomaly detection ANO_DET described more generally above in FIG. 2.

The respective local model LM1, LM2 is trained with training data that can be assigned to an anomaly-free state in the sensor data SD1.

The respective model output variables RD are formed by a plurality of parameter values, and the respective threshold value TH1, TH2 is defined by correspondingly assignable values or limit values of ranges.

The sensor data and training data is formed as image data.

The global model weightings W_GM and the global threshold value TH_GM are transmitted from the server S to the second client C2, which has an autoencoder with a similar local model.

The similarity is determined via predefined ranges for the local model weightings W1, W2 between the first and second clients C1, C2.

For a respective local threshold value TH1, TH2, metadata with regard to the local threshold value TH1, TH2 and the first and at least one second local model can also be captured by a first or at least one second client C1, C2 and transmitted to the server S, and when generating and training AGGR of the global model GM, the metadata is applied, for example, with a correspondingly adjusted weighting of the individual model weightings W1, W2.

Thus, accurate data of a model and a threshold value of a “reference” client can be weighted more strongly than clients with less accurate training data.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A computer-implemented method for anomaly detection in sensor data, comprising:
a) generating and training a first and at least one second local model based on an autoencoder, each model comprising local model weightings and a local model output variable, and determining a local threshold value for a respective local model output variable aided by at least one of (i) a mean value and (ii) a standard deviation of local threshold values via a first or at least one second client;
b) transmitting the local model weightings and the local threshold values from the first and the at least one second client to a server;
c) generating and training a global model based on the autoencoder utilizing the local model weightings, the global model comprising global model weightings and a local model output variable, and determining a global threshold value for a global model output variable aided by at least one of (i) the mean value and (ii) the standard deviation of the local threshold values by the server;
d) transmitting the global model weightings and global threshold value to the first client, and adopting the global model weightings for the first local model of the first client;
e) capturing first sensor data by a first sensor, which the first client possesses;
f) applying the first sensor data to the first local model and determining a local model output variable of the first client; and
g) detecting an anomaly for the sensor data by the first client, if the local model output variable is outside a range which is fixed by the global threshold value.

13. The method as claimed in claim 12, wherein said training of a respective local model is performed with training data which is assignable to an anomaly-free state in the sensor data.

14. The method as claimed in claim 12, wherein a respective model output variable is formed by at least one parameter value, and a respective threshold value is defined by at least one corresponding assignable value or a range limit of a range.

15. The method as claimed in claim 12, wherein the sensor data and training data is formed as image data.

16. The method as claimed in claim 12, wherein the global model weightings and the global threshold value are transmitted from the server to the at least one second client, which has an autoencoder with a similar local model; and wherein similarity is determined via predefined ranges for the local model weightings between the first and at least one second clients.

17. The method as claimed in claim 12, wherein for a respective local threshold value metadata with respect to the local threshold value and the first and at least one second local models is also acquired by the first or at least one second client and transmitted to the server, and when generating and training the global model, the metadata is applied when weighting individual model weightings.

18. A system for anomaly detection in sensor data, comprising:
a first and at least one second client each having a client processor and a client memory;
a sensor; and
a connected server having a server processor and a server memory;
wherein the system is configured to:
a) generate and train a first and at least one second local model based on an autoencoder, each model comprising local model weightings and a local model output variable, and determine a local threshold value for a respective local model output variable aided by at least one of (i) a mean value and (ii) a standard deviation of local threshold values via the first or at least one second client;
b) transmit the local model weightings and the local threshold values from the first and the at least one second client to the server;
c) generate and train a global model based on the autoencoder utilizing the local model weightings, the global model comprising global model weightings and a local model output variable, and determine a global threshold value for a global model output variable aided by at least one of (i) the mean value and (ii) the standard deviation of the local threshold values by the server;
d) transmit the global model weightings and global threshold value to the first client, and adopt the global model weightings for the first local model of the first client;
e) capture first sensor data by the sensor;
f) apply the first sensor data to the first local model and determine a local model output variable of the first client; and
g) detect an anomaly for the sensor data by the first client, if the local model output variable is outside a range which is fixed by the global threshold value.

19. The system as claimed in the preceding claim 18, wherein the sensor is an imaging sensor.

20. A computer program, comprising instructions which, when executed by a processors of a system having memories, cause the system to perform the method as claimed in claim 12.

21. A non-transitory electronically readable data carrier encoded with readable control information comprising at least a computer program which, when using the data carrier in a computing facility, implements the method as claimed in claim 12.

22. A data carrier signal which transmits the computer program as claimed in claim 20.
